(19) United States
(12) Patent Application Publication
(10) Pub. No.: US 2026/0307602 A1
(43) Pub. Date: Oct. 8, 2026

(54) WIRE HARNESS

(71) Applicants: SUMITOMO WIRING SYSTEMS, LTD., Yokkaichi-shi, Mie-ken (JP); TOYOTA JIDOSHA KABUSHIKI KAISHA, Toyota-shi, Aichi-ken (JP)

(72) Inventors: Tomoki TANIGUCHI, Yokkaichi-shi, Japan (JP); Satoshi SASAKI, Yokkaichi-shi, Japan (JP); Takuya MURATA, Yokkaichi-shi, Japan (JP); Yoshihiro YAMAMOTO, Yokkaichi-shi, Japan (JP); Hironari TOYODA, Toyota-shi (JP)

(21) Appl. No.: 18/875,172

(22) PCT Filed: Jun. 16, 2023
(86) PCT No.: PCT/JP2023/022410

§ 371 Date: Dec. 16, 2024

(30) Foreign Application Priority Data
Jun. 23, 2022 (JP) 2022-101121

(51) Int. Cl. B60R 16/02; H01B 3/28; H01B 17/30; H01B 17/58

(52) U.S. Cl. CPC B60R 16/0215; H01B 3/28; H01B 17/303; H01B 17/583

(57) ABSTRACT

A wire harness includes an electric wire, a grommet, a water shut-off valve, a shield material, a first close contact layer, and a second close contact layer. The grommet is attached to, for example, a vehicle body and houses the electric wire inside. The water shut-off valve is provided to shut off water inside the grommet and attached by allowing the electric wire to pass therethrough. The shield material is attached around the water shut-off valve. The first close contact layer is attached to the outer circumference of the shield material, thereby causing the shield material to closely contact with the water shut-off valve. The second close contact layer is attached to the outer circumference of the first close contact layer, thereby causing the first close contact layer to closely contact with the shield material.

### CROSS REFERENCE TO RELATED APPLICATIONS

This application is a National Stage of International Application No. PCT/JP2023/022410 filed Jun. 16, 2023, claiming priority based on Japanese Patent Application No. 2022-101121 filed Jun. 23, 2022.

### TECHNICAL FIELD

The present invention relates to a wire harness.

### BACKGROUND ART

Patent Literature 1 discloses a typical wire harness including an external conductor that acts as a shield against electromagnetic waves. The external conductor includes, for example, a substantially cylindrical conductor tube formed from aluminum. The aluminum conductor tube has a relatively high rigidity. Thus, in a limited arrangement space, the conductor tube may restrict the position of the wire harness and hinder arrangement of the wire harness.

Accordingly, Patent Literature 2 discloses a wire harness that uses a braided shield. Such a wire harness includes a water-blocking plug that fills a gap between electric wires and a grommet. The braided shield is arranged to cover the outer circumference of the water-blocking plug. A water-blocking adhesive member is attached to the outer circumferential surface of the braided shield. The braided shield has flexibility. Thus, the wire harness may be bent and arranged in a limited arrangement space. The wire harness of Patent Literature 2 allows the wire harness to be arranged even in a limited arrangement space.

### CITATION LIST

### Patent Literature

Patent Literature 1: Japanese Laid-Open Patent Publication No. 2015-53771

Patent Literature 2: Japanese Laid-Open Patent Publication No. 2016-119821

### SUMMARY OF INVENTION

### Technical Problem

When the wire harness is bent, the bending load applied may lower the adhesion between the water-blocking plug and the braided shield, the adhesion between the braided shield and the water-blocking adhesive member, or the like. Such bending may result in formation of a gap that was not initially present, and a fluid, such as water, may flow into the gap. Accordingly, there is a need for improving the waterproofness of a bendable wire harness.

An objective of the present disclosure is to provide a wire harness with improved waterproofness.

### Solution to Problem

A wire harness that solves the above problem includes an electric wire, a grommet, a water-blocking plug, a shielding member, a first close contact layer, and a second close contact layer. The electric wire transmits electric power. The grommet is configured to be attached to an opening through which the electric wire extends and to accommodate the electric wire. The electric wire extends through the water-blocking plug. The water-blocking plug is arranged to block entry of water into the grommet. The shielding member is attached to a circumference of the water-blocking plug. The first close contact layer is attached to an outer circumference of the shielding member so that the shielding member is tightly fitted to the water-blocking plug. The second close contact layer is attached to an outer circumference of the first close contact layer so that the first close contact layer is tightly fitted to the shielding member.

### Advantageous Effects of Invention

The present disclosure improves the waterproofness of the wire harness.

### BRIEF DESCRIPTION OF DRAWINGS

FIG. 1 is a perspective view of a wire harness.

FIG. 2 is a front view of the wire harness.

FIG. 3 is an exploded perspective view of the wire harness.

FIG. 4 is a cross-sectional view taken along line IV-IV shown in FIG. 2.

FIG. 5 is a cross-sectional view taken along line V-V shown in FIG. 2.

FIGS. 6A, 6B, 6C, and 6D are diagrams illustrating a manufacturing procedure of the wire harness.

FIG. 7 is a diagram illustrating an operation of the wire harness.

FIGS. 8A, 8B, 8C, and 8D are diagrams illustrating another manufacturing procedure of the wire harnesses.

### DESCRIPTION OF EMBODIMENTS

Embodiments of the present disclosure will now be described.

(1) A wire harness in accordance with the present disclosure includes an electric wire, a grommet, a water-blocking plug, a shielding member, a first close contact layer, and a second close contact layer. The electric wire transmits electric power. The grommet is configured to be attached to an opening through which the electric wire extends and to accommodate the electric wire. The electric wire extends through the water-blocking plug. The water-blocking plug is arranged to block entry of water into the grommet. The shielding member is attached to a circumference of the water-blocking plug. The first close contact layer is attached to an outer circumference of the shielding member so that the shielding member is tightly fitted to the water-blocking plug. The second close contact layer is attached to an outer circumference of the first close contact layer so that the first close contact layer is tightly fitted to the shielding member.

With this structure, the first close contact layer tightly fits the shielding member to the water-blocking plug, and the second close contact layer tightly fits the first close contact layer to the shielding member. In this manner, the two layers, namely, the first close contact layer and the second close contact layer, tightly fit the components to one another. This avoids formation of gaps between the components and improves the waterproofness of the bendable wire harness.

(2) In the above aspect (1), the shielding member is a braided shield formed by strands. Further, the first close contact layer includes at least a butyl-based rubber. With this structure, the butyl-based rubber is caught into the meshes of the braided shield so that the butyl-based rubber is firmly fitted to the shielding member. This strengthens the adhesion between the water-blocking plug and the shielding member and further improves the waterproofness thereof.

(3) In the above aspect (2), the first close contact layer is a butyl-based rubber sheet that includes at least a butyl-based rubber. The butyl-based rubber sheet is wound around the braided shield in multiple turns while shifting a position of the butyl-based rubber sheet in an axial direction of the electric wire, and a pressure is applied to the butyl-based rubber sheet by a jig so that the butyl-based rubber sheet is tightly fitted to the braided shield. This structure allows the butyl-based rubber sheet to be attached to the circumference of the braided shield by carrying out a simple task such as wrapping the butyl-based rubber sheet around the braided shield. Further, after attaching the butyl-based rubber sheet, a pressure is applied to the butyl-based rubber sheet by the jig so that the butyl-based rubber sheet is firmly fitted to the braided shield.

(4) In any one of the above aspects (1) to (3), the second close contact layer is a tape that is wound in multiple turns while shifting a position of the tape in an axial direction of the electric wire. With this structure, the tape is readily wrapped around the first close contact layer.

(5) In any one of the above aspects (1) to (4), the grommet includes an inner surface on which an annular seal is arranged to water-tightly seal a gap between the grommet and the second close contact layer. This structure improves the waterproofness between the grommet and the second close contact layer.

(6) In any one of the above aspects (1) to (5), the water-blocking plug includes a hole through which the electric wire extends. The hole is defined by a wall on which an annular seal is arranged to water-tightly seal a gap between the wall of the hole and the electric wire. This structure improves the waterproofness between the electric wire and the water-blocking plug.

(7) In any one of the above aspects (1) to (6), the grommet includes a tubular portion and a seal portion. The tubular portion accommodates an assembly that includes the water-blocking plug, the electrical wire, the shielding member, the first close contact layer, and the second close contact layer. The seat portion supports a proximal end of the tubular portion. With this structure, the shape of the wire harness is readily changed when the tubular portion is bent from the seat portion. Thus, the wire harness is readily bent.

(8) In any one of the above aspects (1) to (7), the seat portion includes a water-blocking wall formed in a circumferential shape continuously extending along an entire edge of the seat portion. With this structure, the wall blocks entry of a fluid, such as water. This further improves the waterproofness.

### Detailed Description of Embodiments of the Present Disclosure

Specific examples of a wire harness in accordance with the present disclosure will be described below with reference to the drawings. The present invention is not limited to the illustrated embodiments and intended to be defined by the claims and their equivalents, and all variations within the scope of the claims and their equivalents. To facilitate understanding, configurations may be partially exaggerated or simplified in the drawings.

Further, elements in the drawings may not be to scale.

### Overview of Wire Harness 1

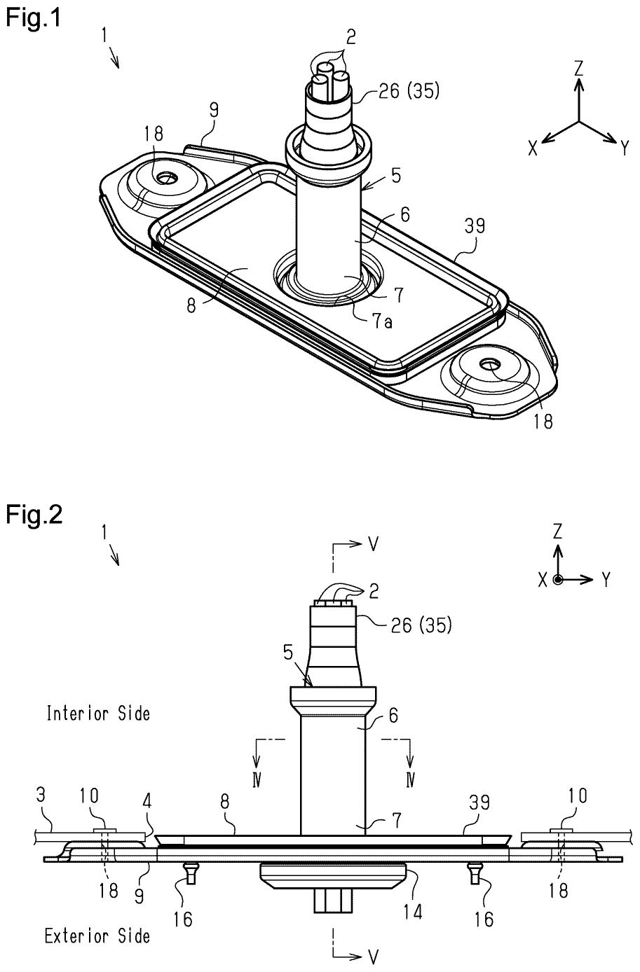

As shown in FIG. 1, a wire harness 1 includes electric wires 2 that transmit electric power. Each of the electric wires 2 is, for example, a coated wire in which a core wire is covered by an insulation sheath. The core wire may be, for example, either a stranded wire or a single-core wire. The single-core wire is, for example, a columnar conductor having a solid inner structure or a tubular conductor having a hollow inner structure. The material of the core wire is, for example, a metal material that is copper-based, aluminum-based, or the like. For example, the insulation sheath entirely covers an outer circumferential surface of the core wire in a circumferential direction. The insulation sheath is formed from, for example, an insulative resin material. The quantity of electric wires 2 does not have to be two or more and may be one.

As shown in FIGS. 1 and 2, the wire harness 1 includes a grommet 5 that protects the electric wires 2 inserted through an opening 4 arranged in an attachment counterpart 3 (shown in FIG. 2). The grommet 5 accommodates the electric wires 2, and is attached to the opening 4 through which the electric wires 2 extend. The grommet 5 includes a tubular portion 6 and a seat portion 8. The electric wires 2 extend through the tubular portion 6. The seat portion 8 supports a proximal end 7 of the tubular portion 6. The grommet 5 is attached to the opening 4 with a bracket 9. The bracket 9 is fixed to the attachment counterpart 3 by, for example, fasteners 10. The fasteners 10 are, for example, bolts. The attachment counterpart 3 is, for example, a body of a vehicle.

The grommet 5 is arranged, for example, on a portion of the attachment counterpart 3 that divides the interior and exterior of the passenger compartment. In the present example, the grommet 5 is arranged such that the tubular portion 6 is located at the interior side and the seat portion 8 is located at the exterior side. A recess 7a is arranged in the proximal end 7 of the grommet 5 to facilitate bending of the grommet 5.

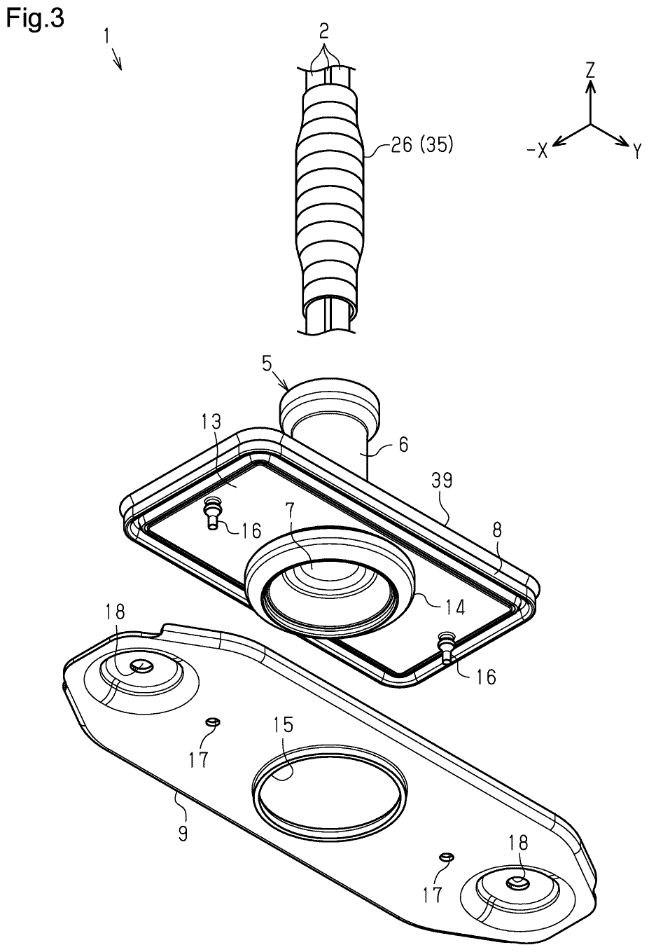

As shown in FIG. 3, the seat portion 8 includes a plate-shaped body 13 placed on the bracket 9, and a flange 14 arranged on a back surface of the body 13. The flange 14 is located on the back surface of the body 13. The grommet 5 is attached to the attachment counterpart 3 by engaging the flange 14 with the edge of a hole 15 arranged in the bracket 9. The bracket 9 includes positioning holes 17 for receiving pins 16 projecting from the back surface of the seat portion 8 (body 13). The bracket 9 further includes a hole 18 in each of two opposite ends for receiving the fasteners 10.

### Water-blocking Structure for Electric Wires 2 in Grommet 5

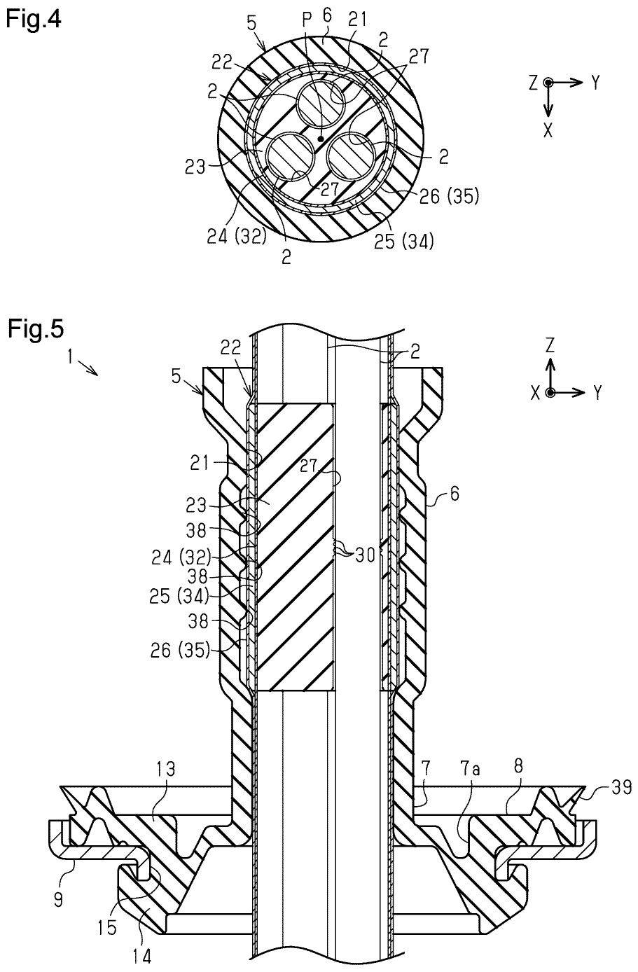

As shown in FIGS. 4 and 5, the grommet 5 accommodates an assembly 22 that water-tightly seals a gap between an inner circumferential surface 21 of the grommet 5 and the electric wires 2. The assembly 22 includes, for example, a water-blocking plug 23, a shielding member 24, a first close contact layer 25, and a second close contact layer 26. In the present example, the assembly 22 is arranged in the tubular portion 6 of the grommet 5. The assembly 22 stops entry of a fluid, such as water, into the grommet 5.

The electric wires 2 extend through the water-blocking plug 23, and the water-blocking plug 23 is arranged to block entry of water or the like into the grommet 5. The water-blocking plug 23 is, for example, a rubber plug. The water-blocking plug 23 has holes 27 through which the electric wires 2 extend, respectively. In the present example, three holes 27 extend in an axial direction of the electric wires 2 (Z-axis direction in FIG. 4). The holes 27 are arranged at equal angular intervals about an axis P of the grommet 5 (refer to FIG. 4).

As shown in FIG. 5, each of the holes 27 is defined by a wall on which an annular seal 30 is arranged to water-tightly seal a gap between the wall of the hole 27 and a corresponding one of the electric wires 2. In the present example, a plurality of seals 30 (three in the present example) is arranged at a central position in the axial direction of the electric wires 2 (Z-axis direction in FIG. 5). The seal 30 is, for example, a lip-type seal that is elastically deformed in a sealing state.

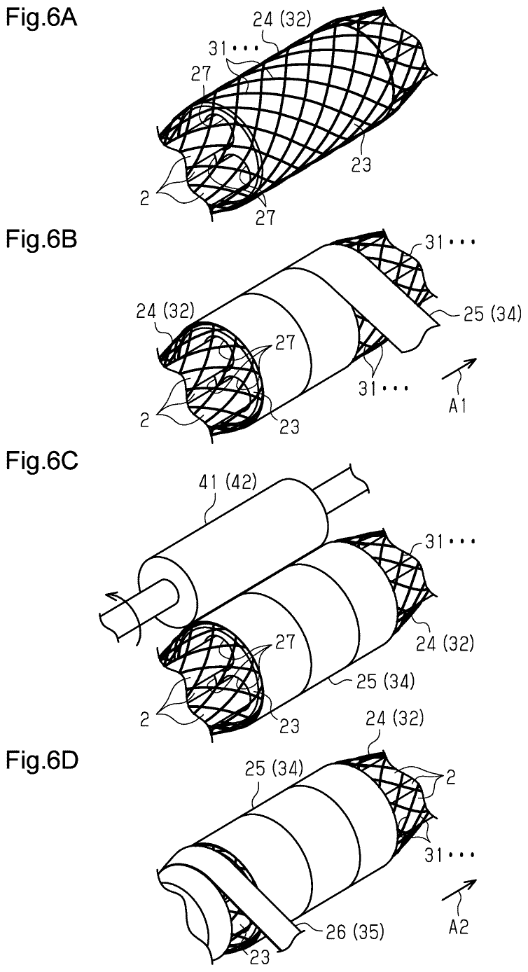

The shielding member 24 is attached to the circumference of the water-blocking plug 23. The shielding member 24 surrounds the water-blocking plug 23. The shielding member 24 is, for example, a braided shield 32 formed from strands 31 (refer to FIGS. 6A, 6B, 6C, and 6D). Each strand 31 is, for example, a metal strand. For example, the shielding member 24 has flexibility. Also, the shielding member 24 avoids electrical noise or crosstalk and improves strength against rubbing or the like.

The first close contact layer 25 is attached to the outer circumference of the shielding member 24 so that the shielding member 24 is tightly fitted to the water-blocking plug 23. The first close contact layer 25 includes, for example, at least a butyl-based rubber. In the present example, the first close contact layer 25 is a butyl-based rubber sheet 34 that includes at least a butyl-based rubber. The butyl-based rubber sheet 34 is, for example, wound around the braided shield 32 in multiple turns while shifting the position of the butyl-based rubber sheet 34 in the axial direction of the electric wires 2 (Z-axis direction in FIG. 5). Then, a pressure is applied to the wound butyl-based rubber sheet 34 so that the butyl-based rubber sheet 34 is fitted to the braided shield 32.

The second close contact layer 26 is attached to the outer circumference of the first close contact layer 25 so that the first close contact layer 25 is tightly fitted to the shielding member 24. The second close contact layer 26 is, for example, a tape 35 that is wound in multiple turns while shifting the position of the tape 35 in the axial direction of the electric wires 2 (Z-axis direction in FIG. 5). Preferably, the tape 35 has a relatively high flexibility, a relatively high insulating property, a heat resistance, and a low-temperature resistance. The tape 35 is, for example, a vinyl tape.

### Other Water-Blocking Structures

As shown in FIG. 5, the grommet 5 includes the inner surface on which an annular seal 38 is arranged to water-tightly seal a gap between the grommet 5 and the second close contact layer 26. In the present example, three seals 38 are formed at equal intervals in the axial direction of the electric wires 2 (Z-axis direction in FIG. 5). Each of the seals 38 is, for example, a projection projecting from the inner surface of the grommet 5 by a predetermined amount. The seal 38 is, for example, a lip-type seal that is elastically deformed in a sealing state.

As shown in FIGS. 1 to 3 and 5, the seat portion 8 includes a water-blocking wall 39 formed in a circumferential shape continuously extending along the entire edge of the seat portion 8. The wall 39 is shaped to project diagonally from the body 13 of the seat portion 8. The wall 39 prevents a fluid, such as water, from reaching the upper surface (head surface) of the seat portion 8 from the surroundings.

The operation of the wire harness 1 in accordance with the present embodiment will now be described.

### Assembly of Wire Harness 1

As shown in FIG. 6A, the shielding member 24 (braided shield 32 in the present example) is attached to the circumference of the water-blocking plug 23 in which the electric wires 2 are respectively arranged in the holes 27. The shielding member 24 is attached to cover both the electric wires 2 and the water-blocking plug 23. Specifically, the shielding member 24 is attached to both the water-blocking plug 23 and the electric wires 2 in the vicinity of the water-blocking plug 23.

As shown in FIG. 6B, after attaching the shielding member 24, the first close contact layer 25 is attached to the circumference of the shielding member 24. In a case in which the first close contact layer 25 is the butyl-based rubber sheet 34, the butyl-based rubber sheet 34 is wrapped around the shielding member 24 in multiple turns. Specifically, the butyl-based rubber sheet 34 is wrapped around the shielding member 24 in multiple turns while shifting the position of the butyl-based rubber sheets 34 in the axial direction of the electric wires 2 (direction indicated by arrow Al shown in FIG. 6B) such that adjacent parts of the butyl-based rubber sheets 34 overlap each other by a predetermined amount (e.g., spiral wrap).

As shown in FIG. 6C, after winding the butyl-based rubber sheet 34, a pressure is applied to the butyl-based rubber sheet 34 by a jig 41. Specifically, a roller 42, which serves as the jig 41, applies a rolling pressure to the butyl-based rubber sheet 34 and presses the butyl-based rubber sheet 34 against the braided shield 32. In this manner, in a case in which the shielding member 24 is the braided shield 32, the butyl-based rubber sheet 34 is caught into the meshes of the braided shield 32. Thus, the butyl-based rubber sheet 34 is well-fitted to the braided shield 32.

As shown in FIG. 6D, after applying pressure to the butyl-based rubber sheet 34, the second close contact layer 26 is attached to the circumference of the first close contact layer 25. In a case in which the second close contact layer 26 is the tape 35, the tape 35 is wrapped around the first close contact layer 25 in multiple turns. Specifically, the tape 35 is wrapped around the first close contact layer 25 in multiple turns while shifting the position of the tape 35 in the axial direction of the electric wires 2 (direction indicated by arrow A2 shown in FIG. 6D) such that adjacent parts of the tape 35 overlap each other by a predetermined amount (e.g., spiral wrap). Preferably, the tape 35 is attached to cover the entire shielding member 24. In this manner, the assembly 22 is assembled.

As shown in FIG. 5, after assembling the assembly 22, the assembly 22 is inserted into the grommet 5. In the present example, the assembly 22 is inserted into the grommet 5 so that the second close contact layer 26 is in contact with the seal 38 located in the grommet 5. Further, the assembly 22 is arranged in the tubular portion 6 of the grommet 5.

### Advantages of Wire Harness 1 of the Present Example

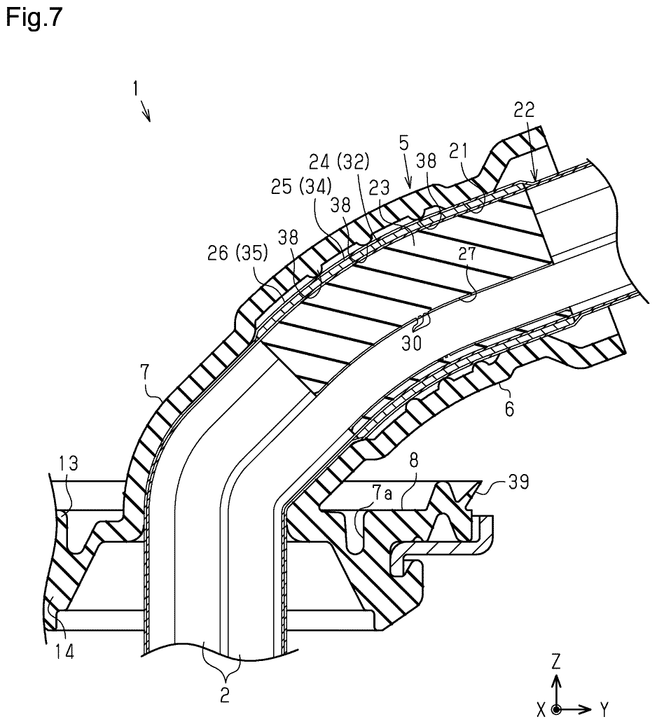

As shown in FIG. 7, an arrangement space for the wire harness 1 may be limited.

For example, an arrangement space has a limited height. In the present example, the shielding member24 has flexibility so that the wire harness 1 may be bent for arrangement.

The first close contact layer 25 and the second close contact layer 26 may also be bent. This facilitates bending of the wire harness 1. In this manner, the orientation (inclination) of the wire harness 1 may be freely changed. Thus, the wire harness 1 can be laid out even in a limited arrangement space.

The first close contact layer 25 is wrapped around the shielding member 24 so that the shielding member 24 is tightly fitted to the water-blocking plug 23. Specifically, the first close contact layer 25 is wrapped around the outer circumference of the shielding member 24 such that a gap is not formed between the shielding member 24 and the water-blocking plug 23. This improves the waterproofness between the water-blocking plug 23 and the shielding member 24.

The butyl-based rubber sheet 34 is used as the first close contact layer 25. The butyl-based rubber sheet 34 is wrapped around the shielding member 24, and then a pressure is applied by the jig 41. Thus, in a case in which the shielding member 24 is the braided shield 32, the pressure applied presses the butyl-based rubber sheet 34 into the meshes of the braided shield 32 and fits the butyl-based rubber sheet 34 to the braided shield 32. This also firmly fixes the shielding member 24 to the water-blocking plug 23.

The second close contact layer 26 is wrapped around the first close contact layer 25 so that the first close contact layer 25 is tightly fitted to the shielding member 24.

Specifically, the second close contact layer 26 is wrapped around the outer circumference of the first close contact layer 25 such that a gap is not formed between the shielding member 24 and the first close contact layer 25. This further improves the waterproofness between the shielding member 24 and the first close contact layer 25.

The butyl-based rubber sheet 34 is adhesive and may adhere to the hand or other parts of a technician. However, in the present example, the second close contact layer 26 covers the circumference of the butyl-based rubber sheet 34 such that the butyl-based rubber sheet 34 is not exposed from the surface. This avoids a situation in which the butyl-based rubber sheet 34 adheres to the hand or other parts of the technician, thereby facilitating handling of these components.

### Advantages of the Embodiment

The wire harness 1 of the above embodiment has the following advantages.

(1) The wire harness 1 includes the electric wires 2, the grommet 5, the water-blocking plug 23, the shielding member 24, the first close contact layer 25, and the second close contact layer 26. The electric wires 2 transmit electric power. The grommet 5 accommodates the electric wires 2, and is attached to the opening 4 through which the electric wires 2 extend. The electric wires 2 extend through the water-blocking plug 23, and the water-blocking plug 23 is arranged to block entry of water or the like into the grommet 5. The shielding member 24 is attached to the circumference of the water-blocking plug 23. The first close contact layer 25 is attached to the outer circumference of the shielding member 24 so that the shielding member 24 is tightly fitted to the water-blocking plug 23. The second close contact layer 26 is attached to the outer circumference of the first close contact layer 25 so that the first close contact layer 25 is tightly fitted to the shielding member 24.

With the present example, the first close contact layer 25 tightly fits the shielding member 24 to the water-blocking plug 23, and the second close contact layer 26 tightly fits the first close contact layer 25 to the shielding member 24. In this manner, the two layers, namely, the first close contact layer 25 and the second close contact layer 26, tightly fit the other components to one another. This avoids formation of gaps between the components and improves the waterproofness of the bendable wire harness 1.

(2) The shielding member 24 is the braided shield 32 formed by the strands 31. The first close contact layer 25 includes at least a butyl-based rubber. With this structure, the butyl-based rubber is caught into the meshes of the braided shield 32 so that the butyl-based rubber is firmly fitted to the shielding member 24. This strengthens the adhesion between the water-blocking plug 23 and the shielding member 24 and further improves the waterproofness thereof.

(3) The first close contact layer 25 is a butyl-based rubber sheet 34 that includes at least a butyl-based rubber. The butyl-based rubber sheet 34 is wound around the braided shield 32 in multiple turns while shifting the position of the butyl-based rubber sheet 34 in the axial direction of the electric wires 2, and a pressure is applied to the butyl-based rubber sheet 34 by the jig 41 so that the butyl-based rubber sheet 34 is tightly fitted to the braided shield 32. This structure allows the butyl-based rubber sheet 34 to be attached to the circumference of the braided shield 32 by carrying out a simple task such as wrapping the butyl-based rubber sheet 34 around the braided shield 32. Further, after attaching the butyl-based rubber sheet 34, a pressure is applied to the butyl-based rubber sheet 34 by the jig 41 so that the butyl-based rubber sheet 34 is firmly fitted to the braided shield 32.

(4) The second close contact layer 26 is the tape 35 that is wound in multiple turns while shifting the position of the tape 35 in the axial direction of the electric wires 2. With this structure, the tape 35 is readily wrapped around the first close contact layer 25.

(5) The grommet 5 includes the inner surface on which the annular seal 38 is arranged to block entry of water or the like into the gap between the grommet 5 and the second close contact layer 26. This structure improves the waterproofness between the grommet 5 and the second close contact layer 26.

(6) The water-blocking plug 23 includes the holes 27 through which the electric wires 2 extend, respectively. Each of the holes 27 is defined by the wall on which the annular seal 30 is arranged to block entry of water into the gap between the wall of the hole 27 and the electric wire 2. This structure improves the waterproofness between the electric wires 2 and the water-blocking plug 23.

(7) The grommet 5 includes the tubular portion 6 that accommodates the assembly 22, and the seat portion 8 that supports the proximal end 7 of the tubular portion 6. The assembly 22 includes the electric wires 2, the water-blocking plug 23, the shielding member 24, the first close contact layer 25, and the second close contact layer 26. With this structure, the shape of the wire harness 1 is readily changed when the tubular portion 6 is bent from the seat portion 8. Thus, the wire harness 1 is readily bent.

(8) The seat portion 8 includes the water-blocking wall 39 formed in a circumferential shape continuously extending along an entire edge of the seat portion 8. With this structure, the wall 39 blocks entry of a fluid, such as water. This further improves the waterproofness.

The present embodiment may be modified as follows. The above embodiment and the following modifications can be combined as long as the combined modifications remain technically consistent with each other.

The shielding member 24 is not limited to the braided shield 32 and may be, for example, a sheet, tube, or the like that acts as a shield against electromagnetic waves.

The first close contact layer 25 does not have to be fitted to the shielding member 24 by applying pressure to the first close contact layer 25 with the roller 42. Instead, the jig 41 may only be pressed directly against the first close contact layer 25.

The first close contact layer 25 does not have to be sheet-shaped and may be, for example, tubular.

The first close contact layer 25 is not limited to a butyl-based rubber (butyl-based rubber sheet 34), and may be only, for example, a bendable member that covers the circumference of the shielding member 24 and presses the shielding member 24 against the water-blocking plug 23.

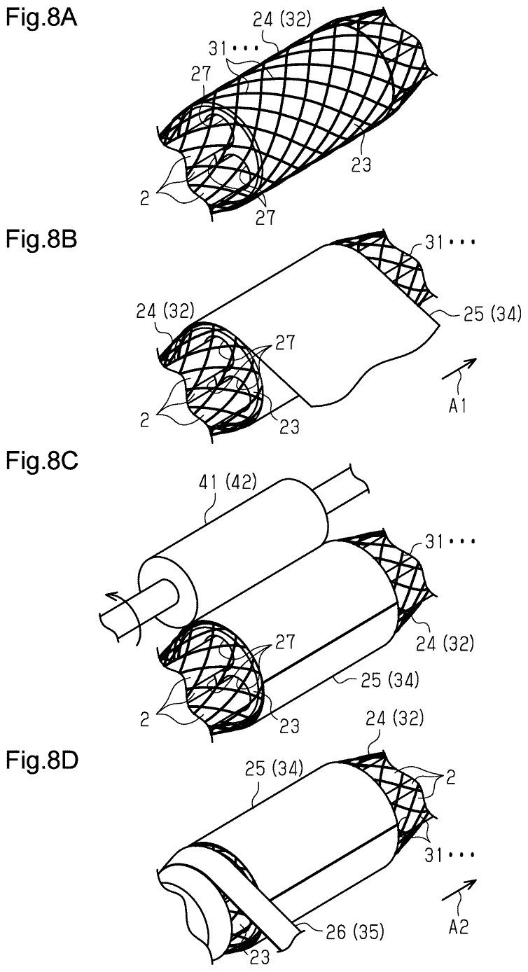

In the example shown in FIGS. 6A to 6D, the first close contact layer 25 is wound in a “half-wrap” (spiral wrap) manner, but the first close contact layer 25 may be wound in a “full-wrap” (circular wrap) manner. As shown in FIGS. 8A to 8D, the first close contact layer 25 may be wrapped around the shielding member 24 in multiple turns while being held at the same position in the axial direction of the electric wires 2. In other words, the first close contact layer 25 may be wrapped around the shielding member 24 in multiple turns without shifting the position of the first close contact layer 25 in the axial direction of the electric wires 2. The first close contact layer 25 may have a dimension (may be referred to as width of the first close contact layer 25) in the axial direction (arrow A1) of the electric wires 2 that is substantially equal to or completely equal to the entire length of the water-blocking plug 23 in the axial direction (arrow A1) of the electric wires 2. In a case in which the first close contact layer 25 is the butyl-based rubber sheet 34, multiple layers of the butyl-based rubber sheet 34 arranged one over another may form a stack of the butyl-based rubber sheets 34 around the water-blocking plug 23 over the entire length of the water-blocking plug 23.

Multiple layers of the first close contact layer 25 may form a roll (roll of multi-layered butyl-based rubber sheets 34) having a length that corresponds to or conforms to the entire length of the water-blocking plug 23. This is advantageous in improving the waterproofness. For example, the number of turns in the roll may be adjusted in accordance with a desired sealing performance. Accordingly, the desired sealing performance may be obtained in a flexible manner.

The tape 35 of the second close contact layer 26 is not limited to a vinyl tape and may be any type of a resin tape.

Preferably, the tape 35 of the second close contact layer 26 is, for example, an insulating tape.

The second close contact layer 26 is not limited to the tape 35 and may be, for example, a tubular member that covers the circumference of the first close contact layer 25. The water-blocking plug 23 is not limited to a rubber plug, and may be formed from any elastic member. Thus, the water-blocking plug 23 may be formed from a material capable of sealing the grommet 5.

The grommet 5 may be directly attached to the attachment counterpart 3, such as the vehicle body, without the bracket 9.

The grommet 5 may only be shaped to protect the electric wires 2 extending through the holes 27.

The assembly 22 does not have to be arranged only in the tubular portion 6. Instead, the assembly 22 may extend across the proximal end 7 and reach the seat portion 8.

The electric wires 2 may be a cable formed by a bundle of electric wires.

The wire harness 1 does not have to be installed in a vehicle and may be used in other devices or apparatus.

### Embodiment 1

As shown in FIGS. 4 and 5, a wire harness (1) in accordance with some examples of the present disclosure may include
electric wires (2) each including an outer circumferential surface;
an elastic water-blocking plug (23) including through holes (27), the through holes (27) being configured to be water-tightly fitted to the outer circumferential surfaces of the electric wires (2), respectively, in a first length portion of the electric wires (2);
a tubular braided shield (24) having a length greater than a length of the water-blocking plug (23), the tubular braided shield (24) being configured to cover the electric wires (2) and the water-blocking plug (23) altogether;
a tubular first close contact layer (25) having a length equal to or corresponding to the length of the water-blocking plug (23), the tubular first close contact layer (25) being configured to be tightly fitted to an outer circumferential surface of the tubular braided shield (24) over the length of the tubular first close contact layer (25); and
a tubular second close contact layer (26) having a length greater than the length of the tubular first close contact layer (25), the tubular second close contact layer (26) being configured to be tightly fitted to an outer circumferential surface of the tubular first close contact layer (25) over the length of the tubular first close contact layer (25); and
a grommet (5) including an elastic tubular portion (6), the elastic tubular portion (6) being configured such that the electric wires (2) extend through the tubular portion (6).

### Embodiment 2

In some examples, as in the examples shown in FIGS. 4 and 5, the water-blocking plug (23), the tubular braided shield (24), the tubular first close contact layer (25), and the tubular second close contact layer (26) may be arranged in this order to form a multilayer structure that covers the first length portion of the electric wires (2).

### Embodiment 3

In some examples, as in the examples shown in FIGS. 4 and 5, the second close contact layer (26) may be tightly fitted to the outer circumferential surface of the tubular braided shield (24) in a second length portion of the electric wires (2) adjacent to the first length portion of the electric wires (2).

### Embodiment 4

In some examples, as in the examples shown in FIGS. 4 and 5,
the multilayer structure including the water-blocking plug (23), the tubular braided shield (24), the tubular first close contact layer (25), and the tubular second close contact layer (26) may be arranged within the elastic tubular portion (6) of the grommet (5); and
the tubular second close contact layer (26) forming a radially outermost surface of the multilayer structure may be in contact with an inner circumferential surface (21) of the tubular portion (6) of the grommet (5) in a watertight manner.

### Embodiment 5

In some examples, as in the examples shown in FIGS. 4 and 5, the outer circumferential surface of the water-blocking plug (23) may be surrounded by the inner circumferential surface (21) of the tubular portion (6) of the grommet (5) without being in direct contact with the inner circumferential surface (21) of the tubular portion (6).

The present disclosure described in accordance with examples is to be considered as illustrative and not restrictive. The present disclosure includes various modified examples and modifications within the scope of equivalence. Additionally, various combinations and modes and one, more, or less of these elements in other combinations and forms are included in the range and conceptual scope of the present disclosure.

### REFERENCE SIGNS LIST

1) wire harness
2) electric wire
3) attachment counterpart
4) opening
5) grommet
6) tubular portion
7) proximal end
7a) recess
8) seat portion
9) bracket
10) fastener
13) body
14) flange
15) hole
16) pin
17) hole
18) hole
21) inner circumferential surface
22) assembly
23) water-blocking plug
24) shielding member
25) first close contact layer
26) second close contact layer
27) hole
30) seal
31) strand
32) braided shield
34) butyl-based rubber sheet
35) tape
38) seal
39) wall
41) jig
42) roller
P) axis

1. A wire harness comprising:
an electric wire for transmitting electric power;
a grommet configured to be attached to an opening through which the electric wire extends and to accommodate the electric wire;
a water-blocking plug through which the electric wire extends, the water-blocking plug being arranged to block entry of water into the grommet;
a shielding member attached to a circumference of the water-blocking plug;
a first close contact layer attached to an outer circumference of the shielding member so that the shielding member is tightly fitted to the water-blocking plug; and
a second close contact layer attached to an outer circumference of the first close contact layer so that the first close contact layer is tightly fitted to the shielding member.

2. The wire harness according to claim 1, wherein
the shielding member is a braided shield formed by strands, and
the first close contact layer includes at least a butyl-based rubber.

3. The wire harness according to claim 2, wherein:
the first close contact layer is a butyl-based rubber sheet that includes at least a butyl-based rubber; and
the butyl-based rubber sheet is wound around the braided shield in multiple turns while shifting a position of the butyl-based rubber sheet in an axial direction of the electric wire, and a pressure is applied to the butyl-based rubber sheet by a jig so that the butyl-based rubber sheet is tightly fitted to the braided shield.

4. The wire harness according to claim 1, wherein the second close contact layer is a tape that is wound in multiple turns while shifting a position of the tape in an axial direction of the electric wire.

5. The wire harness according to claim 1, wherein the grommet includes an inner surface on which an annular seal is arranged to water-tightly seal a gap between the grommet and the second close contact layer.

6. The wire harness according to claim 1, wherein
the water-blocking plug includes a hole through which the electric wire extends, and
the hole is defined by a wall on which an annular seal is arranged to water-tightly seal a gap between the wall of the hole and the electric wire.

7. The wire harness according to claim 1, wherein
the grommet includes
a tubular portion accommodating an assembly that includes the water-blocking plug, the electrical wire, the shielding member, the first close contact layer, and the second close contact layer; and
a seat portion supporting a proximal end of the tubular portion.

8. The wire harness according to claim 7, wherein the seat portion includes a water-blocking wall formed in a circumferential shape continuously extending along an entire edge of the seat portion.
